(19) United States
(12) Patent Application Publication
(10) Pub. No.: US 2003/0043039 A1
(43) Pub. Date: Mar. 6, 2003

(54) Concealed security tags on bottles

(76) Inventors: Robert D. Salemi, Ann Arbor, MI (US); Dennis J. Tate, Grass Lake, MI (US); David W. Dunwiddie, Centennial, CO (US)

Correspondence Address: James M. Deimen, Suite 300, 320 N. Main Street, Ann Arbor, MI, 48104-1192, US

(21) Appl. No.: 10/167,056

(22) Filed: Jun. 11, 2002

Related U.S. Application Data
(60) Provisional application No. 60/297,362, filed on Jun. 11, 2001.

(51) Int. Cl. G08B 13/14

(52) U.S. Cl. 340/572.8; 215/400

(57) ABSTRACT

Security tags for bottles containing valuable or controlled substances are concealed in hidden depressions in the bottle walls and beneath the bottle labels. The security tags are effectively invisible. Alternatively, the hidden depressions may contain fake security tags or the bottles may be molded with integral fake security tags in the depressions.

This application claims the benefit of provisional patent application No. 60/297,362 filed Jun. 11, 2002.

### BACKGROUND OF THE INVENTION

The field of the invention pertains to the manufacture of bottles and, in particular, to bottles shaped for specific purposes.

Bottles are available in an almost infinite variety of shapes for an almost infinite variety of purposes. In recent years, various security devices have been applied to bottles of medicines and foods to indicate previous opening of or tampering with the bottles. In the medicine and pharmaceutical market not only are tampering indicators required but also better means of tracking individual bottles are becoming required. Security tags are becoming a method of tracking individual bottles, in particular, for prescription drugs and other controlled substances; however, they have much broader applications, such as anti-theft devices for non-prescription drugs and all manner of other goods packaged in bottles. In many instances, the existence of the security tags would preferably be disguised. With a view to disguising security tags, the following invention has been developed.

### SUMMARY OF THE INVENTION

The invention comprises the concealment of actual security tags in hidden depressions in the bottle walls and beneath the bottle labels. The tags therefore do not readily appear visible underneath the bottle labels. In some instances, the security tags may preferably not be used on all of the bottles, but rather only on some of the bottles. In such instances the bottle wall hidden depressions are formed to simulate the existence of security tags beneath the labels. Thus, absent removal or tampering with the bottle labels, the existence of actual or fake security tags can not readily be ascertained.

### BRIEF DESCRIPTION OF THE DRAWINGS

FIG. 1 is a side elevation of a bottle showing a security tag;

FIG. 2 is a top view of the bottle of FIG. 1;

FIG. 3 is a partial cutaway view of the bottle and security tag;

FIG. 4 is a perspective view of the bottle and security tag;

FIG. 5 is a perspective view of the bottle and hidden security tag; and

FIG. 6 is an exploded perspective view of the bottle and separate security tag.

### DESCRIPTION OF THE PREFERRED EMBODIMENTS

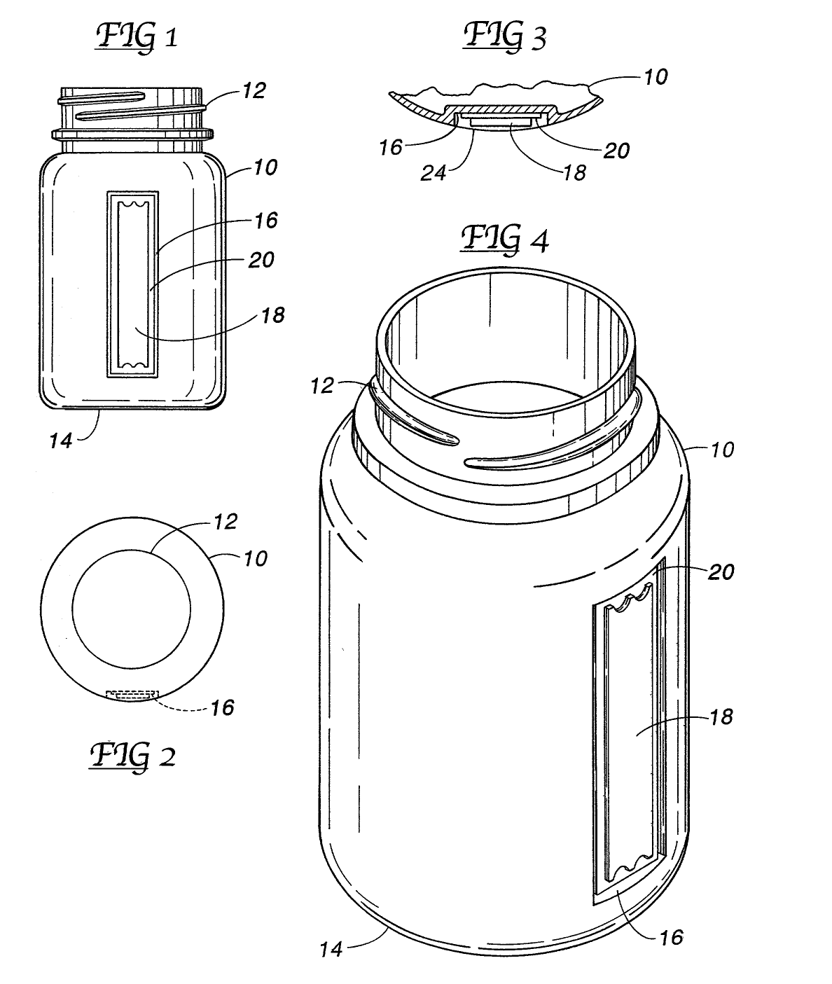

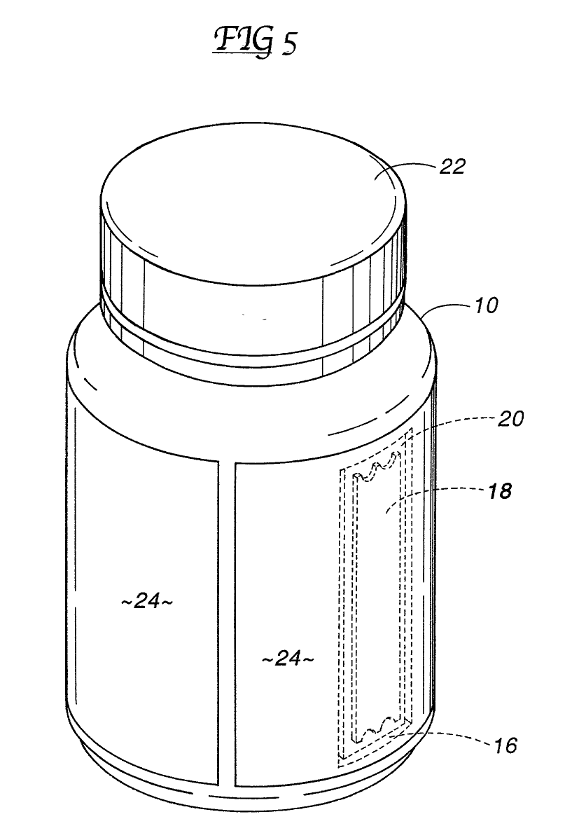

Illustrated in FIGS. 1 through 4 is a bottle 10 having a threaded top 12 and a bottom 14. Although shown as a common cylindrical bottle, the bottle may be of almost any shape that can accommodate a depressed substantially rectangular area 16 formed in the bottle side wall. Within the rectangular depressed area is a security tag 18 mounted on an integral or welded backing piece 20 in turn adhesively fastened in the depressed area 16. As shown, the security tag 18 and backing piece 20 substantially fill the depressed area 16. As alternatives, the backing piece 20 may be separate, formed as a part of the bottle wall or eliminated entirely with the security tag 18 adhered directly to the bottle wall in the depressed area 16. The bottle label 24 encloses the depressed area 16 to hide the security tag 18 as shown in FIG. 3. As further alternatives, the security tags 18 may be affixed to the label 24 backs and the labels applied to position the security tags in the depressions 16, or the security tags may be applied in the bottle molds in the manner of in-mold labeling.

In FIG. 5, the bottle 10 is shown with a cap 22 and a label 24 applied thereto. Shown in dashed outline are the depressed area 16, backing piece 20 and security tag 18. Thus, the security tag 18 is completely hidden where the bottle is formed of opaque plastic or glass. If the bottle and contents are transparent, the backing piece 20 and depressed area 16 are visible; however, the configuration and content of the security tag 18 remain hidden from view if the backing piece 20 is opaque. Although hidden from normal view, the security tag 18 may employ a variety of devices printed or formed thereon that can be read through the label by electronic, electromagnetic or optical devices that function outside of the visible light spectrum.

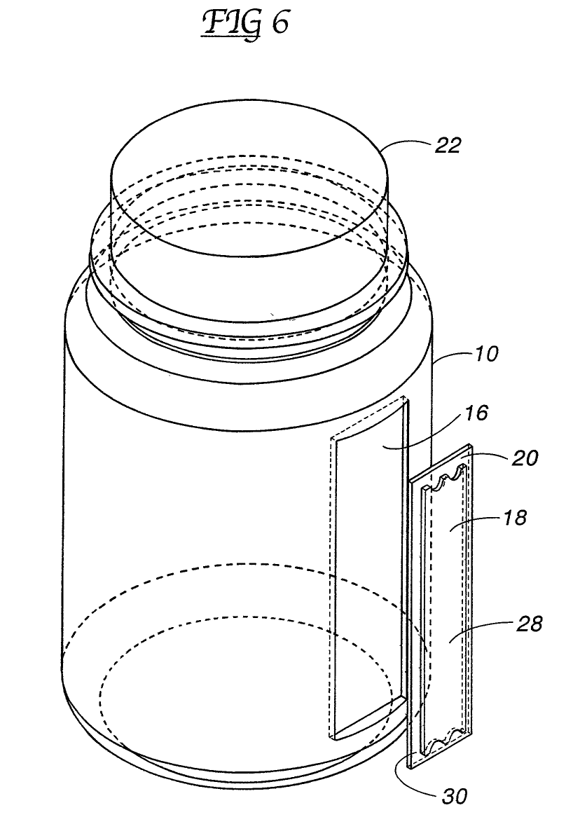

In certain applications, a fake security tag 28 residing under the label 24 is desired. As shown in FIG. 6, an actual security tag 18 and backing piece 20, or fake security tag 28 and backing piece 30, are identical in external configuration and are adhesively attached in depressed area 16. The fake security tag 28 and backing piece 30 may be two pieces or one integral piece. Hidden under a label 24, manual pressure applied to the label 24 will not reveal whether the security tag 18 is real or fake 28. In this embodiment the same bottle 10 with depressed area 16 may be used for a real 18 or fake 28 security tag.

As an alternative, a second bottle configuration may be employed where the bottle 10, fake security tag 28 and backing piece 30 are integral parts of the bottle wall formed by the bottle mold. Thus, in mass production of bottles with fake security tags 28, the step of applying the fake security tags and backing pieces can be eliminated and no change in, or addition to, the labeling step is necessary.

1. A bottle having a top, bottom and sidewall,
a depressed area formed in the sidewall, said depressed area sized to be hidden by a label to be placed thereover and of a depth just sufficient to enable a security tag to be attached in the depressed area prior to placement of a label thereover.

2. The bottle of claim 1 including a security tag attached in the depressed area and a label attached to the bottle, said label covering the security tag and depressed area.

3. The bottle of claim 2 including a security tag having a substrate attached thereto for attachment within the depressed area.

4. The bottle of claim 1 including a fake security tag attached in the depressed area and a label attached to the bottle, said label covering the fake security tag and depressed area.

5. The bottle of claim 1 wherein said depressed area is shaped to simulate the presence of a security tag in the depressed area when a label is placed over the depressed area and attached to the bottle.

6. The bottle of claim 5 wherein the simulated shape of a security tag in the depressed area includes the shape of a simulated substrate beneath the security tag.

7. A method of hiding a security tag on a bottle comprising the steps of:
forming a bottle having a depressed area sized to be hidden by a label,
attaching a security tag in the depressed area, and
covering the depressed area with a label and attaching the label to the bottle.

8. The method of claim 7 wherein the step of attaching a security tag in the depressed area includes the steps of attaching a substrate to the security tag and to the depressed area.

9. A bottle having a top, bottom, sidewall and cap,
a depressed area formed in a portion of the bottle, said depressed area sized to be hidden by a label to be placed thereover and of a depth sufficient to enable a security tag to be attached in the depressed area prior to placement of a label thereover.

10. The bottle of claim 9 including a security tag positioned in the depressed area and a label affixed to the bottle, said label covering the depressed area and security tag.

11. The bottle of claim 10 wherein the security tag is attached to the bottle.

12. The bottle of claim 10 wherein the security tag is attached to the label.

13. The bottle of claim 10 wherein the security tag includes a substrate attaching the security tag to the bottle.

14. The bottle of claim 10 wherein the security tag is a fake security tag.

15. The bottle of claim 9 wherein the depressed area is shaped to simulate the presence of a security tag in the depressed area.

16. The bottle of claim 15 including a label placed over the depressed area and attached to the bottle.

17. The bottle of claim 15 wherein the simulated shape of a security tag in the depressed area includes the shape of a simulated substrate beneath the security tag.

18. The bottle of claim 10 wherein the security tag is attached to the bottle by placing the security tag in a bottle mold just prior to blowing the bottle against the security tag in the manner of in-mold labeling.

19. The method of claim 7 wherein the step of attaching a security tag in the depressed area includes attaching the security tag to the label.

20. The method of claim 7 wherein the step of attaching a security tag in the depressed area includes the step of placing the security tag in a bottle mold just prior to forming the bottle.
